(19) United States
(12) Patent Application Publication
(10) Pub. No.: US 2026/0012983 A1
(43) Pub. Date: Jan. 8, 2026

(54) TRANSMISSION-RECEPTION-CORRESPONDENCE DETERMINATION APPARATUS, TRANSMISSION-RECEPTION-CORRESPONDENCE DETERMINATION METHOD AND PROGRAM

(71) Applicant: NTT, Inc., Tokyo (JP)

(72) Inventors: Kotaro ONO, Tokyo (JP); Kazuhiro TOKUNAGA, Tokyo (JP); Takehiro FUJINAGA, Tokyo (JP); Takeshi KUWAHARA, Tokyo (JP)

(21) Appl. No.: 18/992,362

(22) PCT Filed: Aug. 1, 2022
(86) PCT No.: PCT/JP2022/029556

§ 371 Date: Jan. 8, 2025

(51) Int. Cl. H04W 76/10; H04W 4/029; H04W 64/00

(52) U.S. Cl. CPC H04W 76/10; H04W 4/029; H04W 64/006

(57) ABSTRACT

A transmission-reception-correspondence determination system includes: a processor, and a memory storing program instructions that cause the processor to: record information indicating a relationship between a location of a moving device and time; record identifiers of pieces of information transmitted from the device in association with transmission times of the pieces of information; record an identifier of information transmitted from the device and data observed regarding the information in an apparatus that has received the information via a network in association with each other; and determine that a transmission time associated with an identifier that is same as the recorded identifier among the identifiers of the pieces of information and a location of the device at the transmission time correspond to the data associated with the recorded identifier.

### TECHNICAL FIELD

The present invention relates to a transmission-reception-correspondence determination apparatus, a transmission-reception-correspondence determination method, and a program.

### BACKGROUND ART

Information on a device side that can be acquired by a sensor such as a camera or light detection and ranging (LIDAR) is transmitted to an information processing platform on an edge or cloud side via a network. Information processing, or processes, is performed on the information for users such as humans and AI. In addition, utilizing this information, downlink information transmission such as transmission of a signal for controlling the device side from the information processing platform side and alert notification is performed as necessary. Such a form of edge/cloud computing is being utilized in various fields.

Among a wide variety of sensor information, video is used for a wide variety of applications for humans and AI, and is often focused on and handled as intuitively viewable information. On the other hand, video is information having a relatively large capacity and being costly for transmission and reception via a network. Therefore, a video streaming method for continuously transmitting high-quality real-time information at a low cost and an indicator for evaluating video quality as a reception result are being widely studied mainly in the field of video distribution.

Normally, in a case where the quality of a network itself related to transmission and reception of information is measured, test data or a test packet is transmitted and received between transmission and reception devices of information via the network (see (1) of FIG. 1). Furthermore, in the application layer, for example, a video is transmitted using various video streaming methods (video transmission methods), and how the video quality resulting from reception, its continuity, transmission/reception cost, and the like have changed is analyzed. On the basis of the analysis result, it is possible to evaluate whether or not it is appropriate to use each video streaming method and whether each video streaming method is good or bad as a video transmission method (see (2) in FIG. 1).

### CITATION LIST

### Non-Patent Literature

Non-Patent Literature 1: “The secret of the Internet's ‘time’”, Nikkei Crosstech, [online], [retrieved on Jun. 21, 2022], Internet <URL:https://xtech.nikkei.com/it/article/COLUMN/20081015/316880/>
Non-Patent Literature 2: Hara et al., “A tool for measuring one-way communication latency based on GPS time synchronization”, Distributed systems/Internet operation technology symposium, 1999

### SUMMARY OF INVENTION

### Technical Problem

For example, in a case where a heat map (=a dynamic map of network quality) in consideration of spatio-temporal variation is created for the quality of a network (hereinafter referred to as “NW quality”) used for transmission and reception of information by a device moving on a public road such as an automated vehicle, it is necessary to measure the NW quality on the public road on which the automated vehicle travels. However, measuring the NW quality by stopping on the public road for a certain period of time is difficult in practice because it means occupying the public road. Therefore, it is necessary to measure the NW quality while moving on the public road.

However, in the related art, in a case where the NW quality is measured while moving, there is a problem that it is not strictly known to which transmission event (when and where information is transmitted) data (for example, NW quality or the like) observed on the information receiving side corresponds.

The present invention has been made in view of the above points, and an object of the present invention is to make it possible to ascertain a correspondence relationship between data observed on the receiving side of information and a transmission event.

### Solution to Problem

Therefore, in order to solve the above problem, a transmission-reception-correspondence determination system includes: a time/location information recording unit configured to record information indicating a relationship between a location of a moving device and time; a transmission information recording unit configured to record identifiers of information transmitted from the device in association with transmission times of the information; an observation data recording unit configured to record an identifier of information transmitted from the device and data observed regarding the information in an apparatus that has received the information via a network in association with each other; and a transmission/reception correspondence determination unit configured to determine that a transmission time associated with an identifier that is same as the identifier recorded by the observation data recording unit among the identifiers recorded by the transmission information recording unit and a location of the device at the transmission time correspond to the data associated with the identifier.

### Advantageous Effects of Invention

It is possible to ascertain a correspondence relationship between data observed on the receiving side of information and a transmission event.

### BRIEF DESCRIPTION OF DRAWINGS

FIG. 1 is a diagram illustrating an evaluation method of network quality and a video streaming method.

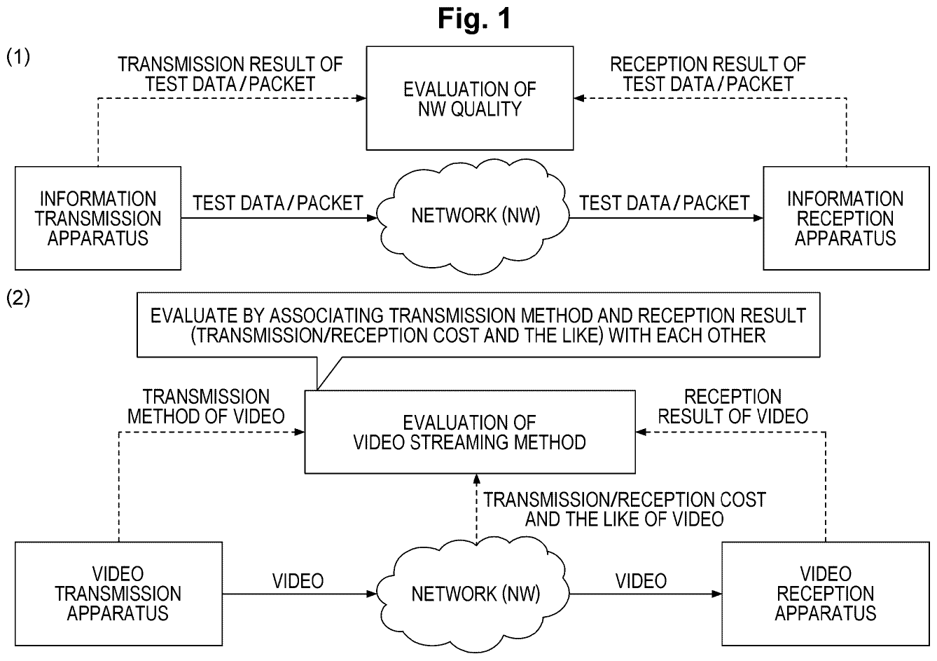

FIG. 2 is a diagram illustrating an example of a configuration of an information processing system according to a first embodiment.

FIG. 3 is a diagram illustrating an example of a hardware configuration of a transmission-reception-correspondence determination apparatus 10 according to the first embodiment.

FIG. 4 is a diagram illustrating an example of a functional configuration of an information processing system according to the first embodiment.

FIG. 5 is a sequence diagram for describing an example of a processing procedure executed in the information processing system according to the first embodiment.

FIG. 6 is a diagram illustrating an example of a configuration of generation information recorded in an information storage unit 18.

FIG. 7 is a diagram illustrating an example of a configuration of transmission information recorded in the information storage unit 18.

FIG. 8 is a diagram illustrating an example of a configuration of time/location information of a device recorded in the information storage unit 18.

FIG. 9 is a diagram illustrating an example of a configuration of reception quality information recorded in the information storage unit 18.

FIG. 10 is a diagram illustrating an example of a configuration of reception result information recorded in the information storage unit 18.

FIG. 11 is a flowchart for describing an example of a processing procedure of determination processing of a correspondence relationship between an information transmission event and NW quality in the first embodiment.

FIG. 12 is a diagram illustrating a state in which a plurality of transmission events are associated with one NW quality.

FIG. 13 is a diagram illustrating an example in which NW quality is recorded in association with a transmission time, a transmission location, and the like.

FIG. 14 is a flowchart for describing an example of a processing procedure of determination processing of a correspondence relationship between an information transmission event and a reception result at a video level in the first embodiment.

FIG. 15 is a diagram illustrating an example in which a reception result at a video level is recorded in association with a transmission time, a transmission location, and the like.

FIG. 16 is a diagram illustrating an example of a functional configuration of an information processing system according to a second embodiment.

FIG. 17 is a sequence diagram for describing an example of a processing procedure executed in the information processing system according to the second embodiment.

FIG. 18 is a flowchart for describing an example of a processing procedure of determination processing of a correspondence relationship between an information transmission event and NW quality in the second embodiment.

FIG. 19 is a flowchart for describing an example of a processing procedure of determination processing of a correspondence relationship between an information transmission event and a reception result at a video level in the second embodiment.

### DESCRIPTION OF EMBODIMENTS

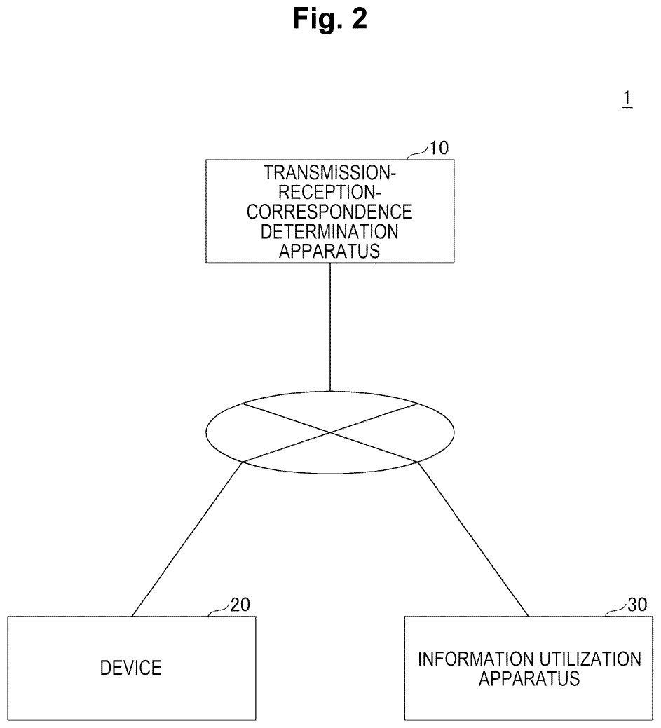

Embodiments of the present invention will be described below with reference to the drawings. FIG. 2 is a diagram illustrating an example of a configuration of an information processing system according to a first embodiment. In FIG. 2, the information processing system includes a device 20, an information utilization apparatus 30, and a transmission-reception-correspondence determination apparatus 10.

The device 20 and the information utilization apparatus 30 are connected to each other via a network such as the Internet including a wireless section and a wired section. The device 20 and the information utilization apparatus 30 are also connected to the transmission-reception-correspondence determination apparatus 10 via a network.

The device 20 is a moving device. For example, the device 20 may be an automated vehicle or the like, or may be another moving object. The device 20 may be self-propelled or may move by being carried by a person or another moving object. The device 20 transmits information acquired from a sensor or the like to the information utilization apparatus 30 via a network while moving. In the present embodiment, it is assumed that information transmitted from the device 20 to the information utilization apparatus 30 is a video. However, the present embodiment may be applied to a case where information other than a video is a transmission target.

The information utilization apparatus 30 is one or more computers that receive information transmitted from the device 20 and utilize (use) the information.

The transmission-reception-correspondence determination apparatus 10 is one or more computers that determine a correspondence relationship between a location and time transmitted by the device 20 for data observed regarding information received by the information utilization apparatus 30.

Note that the information processing system may include two or more devices 20 and two or more information utilization apparatuses 30. The correspondence relationship between the device 20 and the information utilization apparatus 30 may be one-to-one, many-to-one, one-to-many, or many-to-many.

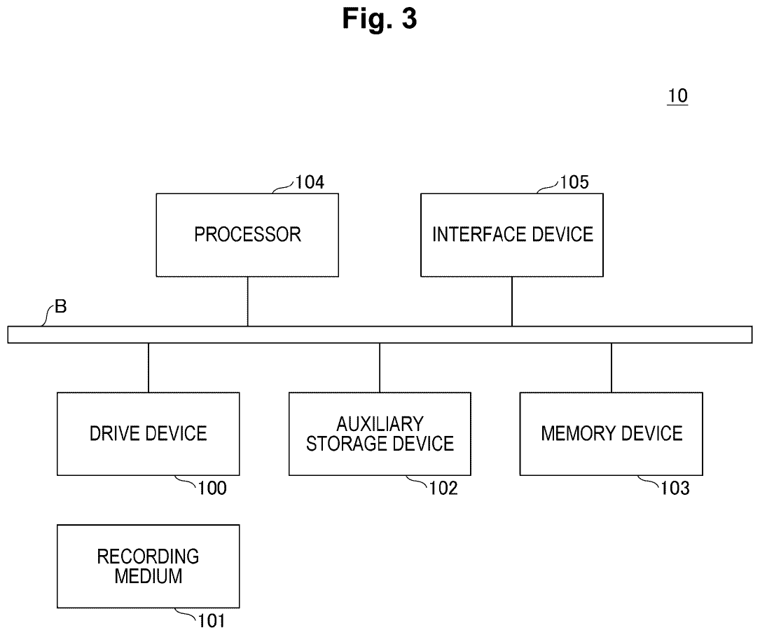

FIG. 3 is a diagram illustrating an example of a hardware configuration of the transmission-reception-correspondence determination apparatus 10 according to the first embodiment. The transmission-reception-correspondence determination apparatus 10 in FIG. 3 includes a drive device 100, an auxiliary storage device 102, a memory device 103, a CPU 104, an interface device 105, and the like which are connected to each other by a bus B.

A program for implementing processing in the transmission-reception-correspondence determination apparatus 10 is provided by a recording medium 101 such as a CD-ROM. When the recording medium 101 storing the program is set in the drive device 100, the program is installed on the auxiliary storage device 102 from the recording medium 101 via the drive device 100. Here, the program is not necessarily installed from the recording medium 101 and may be downloaded from another computer via a network. The auxiliary storage device 102 stores the installed program and also stores required files, data, and the like.

When an instruction to start the program is made, the memory device 103 reads the program from the auxiliary storage device 102 and stores the program. The CPU 104 executes a function related to the transmission-reception-correspondence determination apparatus 10 according to the program stored in the memory device 103. The interface device 105 is used as an interface for connecting to a network.

Note that the device 20 and the information utilization apparatus 30 may also have a hardware configuration as illustrated in FIG. 3.

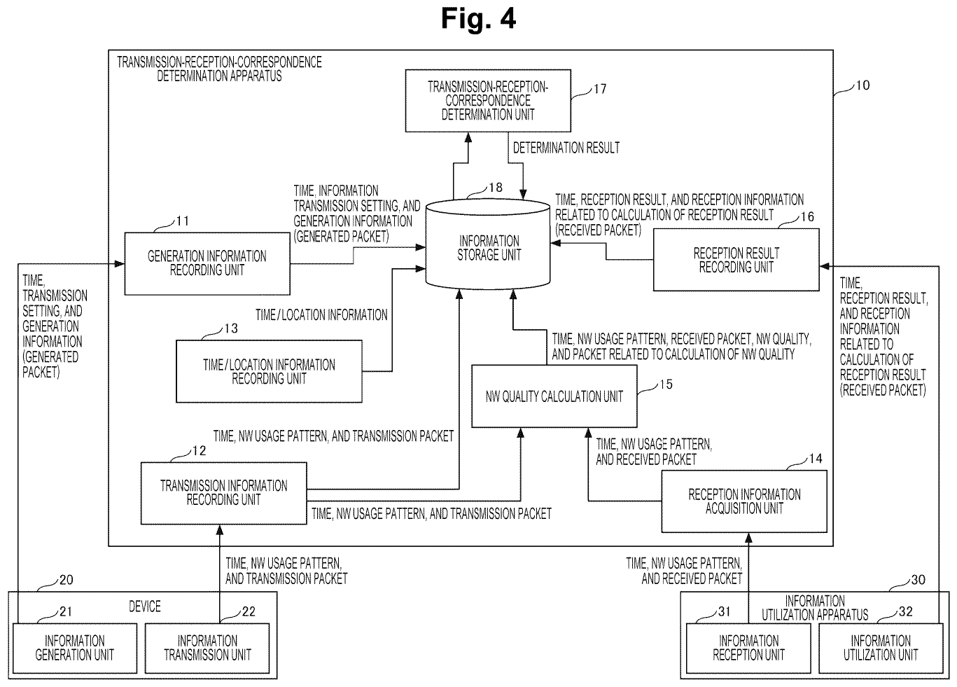

FIG. 4 is a diagram illustrating an example of a functional configuration of the information processing system according to the first embodiment. In FIG. 4, the device 20 includes an information generation unit 21 and an information transmission unit 22. Each of these units is implemented by processing that one or more programs installed in the device 20 cause the processor of the device 20 to execute.

The information utilization apparatus 30 includes an information reception unit 31 and an information utilization unit 32. Each of these units is implemented by processing executed by the processor of the information utilization apparatus 30 according to one or more programs installed in the information utilization apparatus 30.

The transmission-reception-correspondence determination apparatus 10 includes a generation information recording unit 11, a transmission information recording unit 12, a time/location information recording unit 13, a reception information acquisition unit 14, a NW quality calculation unit 15, a reception result recording unit 16, and a transmission-reception-correspondence determination unit 17. Each of these units is implemented by processing executed by the processor 104 by one or more programs installed in the transmission-reception-correspondence determination apparatus 10. The transmission-reception-correspondence determination apparatus 10 also uses an information storage unit 18. The information storage unit 18 can be implemented using, for example, the auxiliary storage device 102, a storage device connectable to the transmission-reception-correspondence determination apparatus 10 via a network, or the like.

Note that the example of the functional configuration illustrated in FIG. 4 is merely an example. For example, an apparatus different from the device 20 may include the information transmission unit 22 (the information generation unit 21 and the information transmission unit 22 may be distributed to different apparatuses). Furthermore, the information reception unit 31 and the information utilization unit 32 may also be distributed to different apparatuses. Further, the device 20 may include the time/location information recording unit 13. Further, the device 20 may include the generation information recording unit 11 and the transmission information recording unit 12. Furthermore, the information utilization apparatus 30 may include the reception information acquisition unit 14, the NW quality calculation unit 15, and the reception result recording unit 16. Furthermore, the device 20 or the information utilization apparatus 30 may include the transmission-reception-correspondence determination unit 17 and the information storage unit 18.

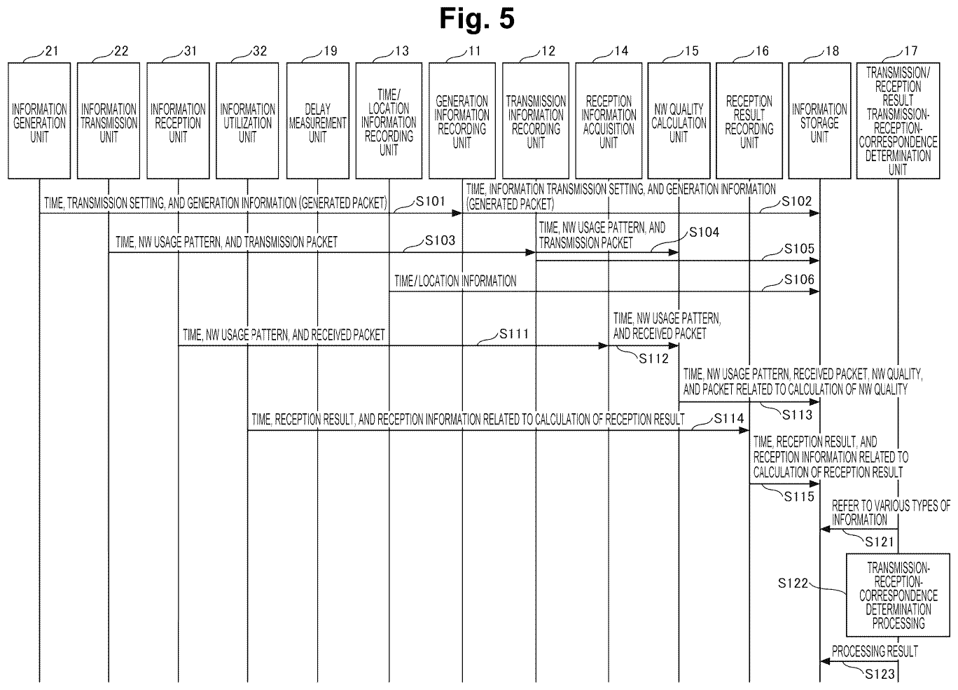

A processing procedure executed in the information processing system will be described below. FIG. 5 is a sequence diagram for describing an example of a processing procedure executed in the information processing system according to the first embodiment.

Upon acquiring (inputting) a video to be transmitted to the information utilization apparatus 30 at an absolute time a, the information generation unit 21 generates a packet Pₐ (a TCP packet, an RTP packet, a QUIC packet, or the like) storing the video, and transmits information (hereinafter referred to as “generation information”) including the absolute time a (hereinafter referred to as an “acquisition time a”), transmission setting Cₐ of the video at the acquisition time a, an identifier of the packet Pₐ, and an information source identifier to the generation information recording unit 11 (S101). The transmission setting Cₐ is, for example, a codec, a resolution, a frame rate, a bit rate, a setting delay, or the like. In addition, the identifier of the packet Pₐ is, for example, a sequence number or a time stamp when the packet Pₐ is a TCP packet or an RTP packet, and is a packet number or the like when the packet Pₐ is a QUIC packet. In the following description, the packet and the identifier of the packet have the same meaning. In addition, the information source identifier is an identifier such as a name of the information generation unit 21 that is a transmission source of the information. In the present embodiment, the name of the device 20 is used as the information source identifier.

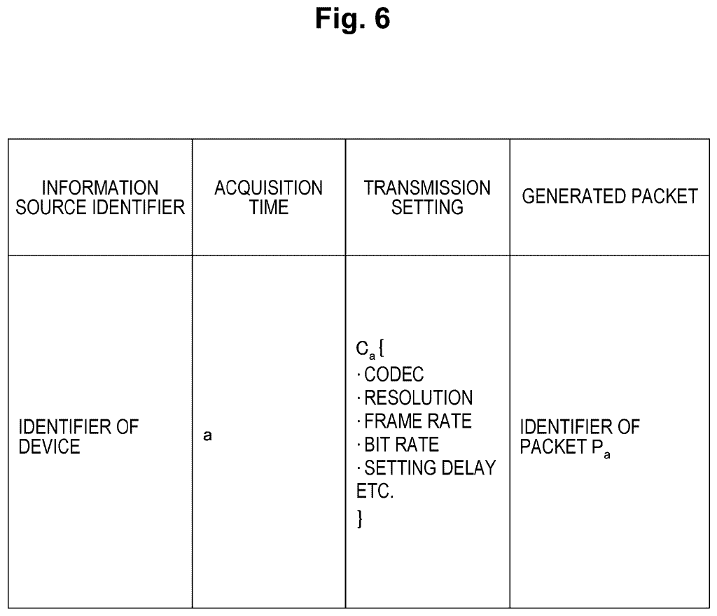

Upon receiving the generation information (information source identifier, a, Cₐ, and Pₐ) from the information generation unit 21, the generation information recording unit 11 records the generation information in the information storage unit 18 (S102). FIG. 6 is a diagram illustrating an example of a configuration of generation information recorded in the information storage unit 18.

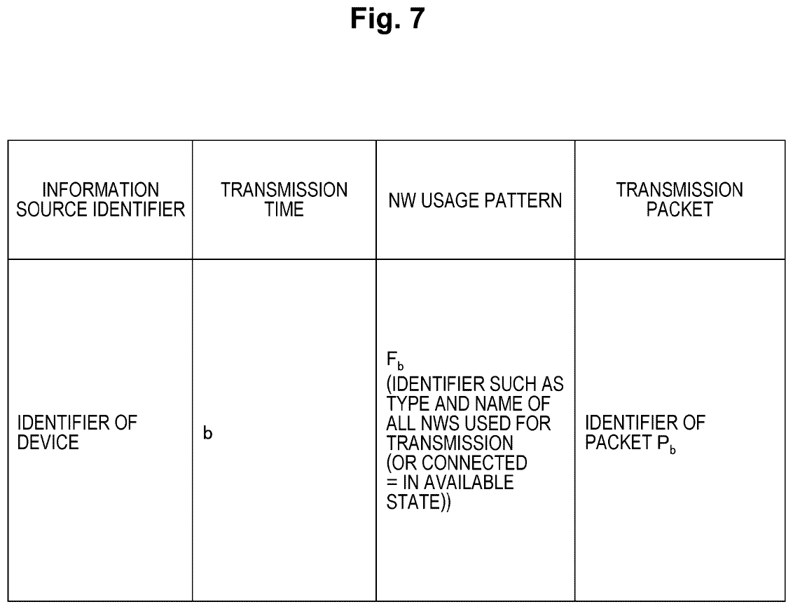

Upon transmitting any one of packets P_{b} generated by the information generation unit 21 to the information reception unit 31 of the information utilization apparatus 30, the information transmission unit 22 records information (hereinafter referred to as “transmission information”) including an absolute time (hereinafter, a “transmission time b”) at which the packet P_{b} has been transmitted, a NW usage pattern F_{b} at the transmission time b, an identifier of the packet P_{b}, and an identifier of the device 20 as an information source identifier in the transmission information recording unit 12 (S103). Note that step S102 is not necessarily synchronized with step S101. Therefore, the packet P_{b} is not necessarily the packet Pₐ (for example, the packet may be a packet generated before the packet Pₐ). The NW usage pattern F_{b} is an identifier such as the type and name of all the networks used (or connected (=in the available state)) by the information transmission unit 22 to transmit the packet P_{b}. The meaning of the identifier of the packet P_{b} is the same as the meaning of the identifier of the packet Pₐ. Upon receiving the transmission information (information source identifier, b, F_{b}, and P_{b}) from the information transmission unit 22, the transmission information recording unit 12 outputs the transmission information to the NW quality calculation unit 15 (S104), and records the transmission information in the information storage unit 18 (S105). FIG. 7 illustrates an example of a configuration of transmission information recorded in the information storage unit 18.

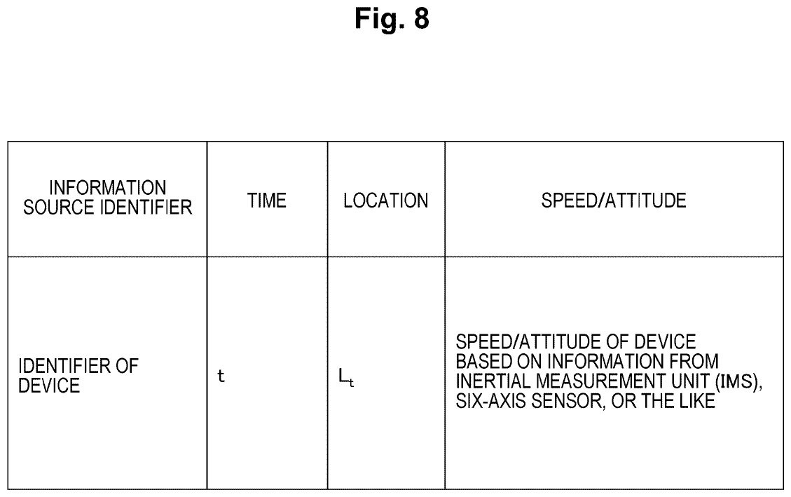

Furthermore, the time/location information recording unit 13 measures the location (latitude, longitude, and altitude) of the device 20 at each time (assuming UTC) using, for example, a positioning calculation function based on a satellite signal such as a GNSS receiver included in the device 20, and records a location Lₜ of the device 20 at each time t (information indicating the relationship between the location of the device 20 and the time) in the information storage unit 18 (S106). FIG. 8 illustrates an example of a configuration of time/location information of the device 20 recorded in the information storage unit 18. Note that FIG. 8 illustrates an example in which the speed and the attitude of the device 20 are also recorded. The speed and the attitude of the device 20 can be measured on the basis of information from an inertial measurement unit (IMS), a six-axis sensor, or the like.

It is assumed that the absolute time of each of the information generation unit 21 and the information transmission unit 22 is synchronized with the absolute time (assuming UTC) acquired by the time/location information recording unit 13 via an NTP server.

On the other hand, upon receiving any one of packets P_{c} transmitted by the information transmission unit 22, the information reception unit 31 transmits information (hereinafter referred to as “reception information”) including an absolute time (hereinafter, a “reception time c”) at which the packet P_{c} has been received, a usage pattern of a network (hereinafter referred to as a “NW usage pattern”) F_{c} at the reception time c, an identifier of the packet P_{c}, and an identifier of the information utilization apparatus 30 to the reception information acquisition unit 14 (S111). Upon receiving the reception information (identifier of the information utilization apparatus 30, c, F_{c}, and P_{c}) from the information reception unit 31, the reception information acquisition unit 14 outputs the reception information to the NW quality calculation unit 15 (S112). Note that the identifier of the packet P_{c} includes information (a type or a name of a network) indicating via which network the packet P_{c} has been received, in addition to the identifier of the packet described above. Further, the reception time c does not necessarily need to be synchronized with another apparatus via the NTP server.

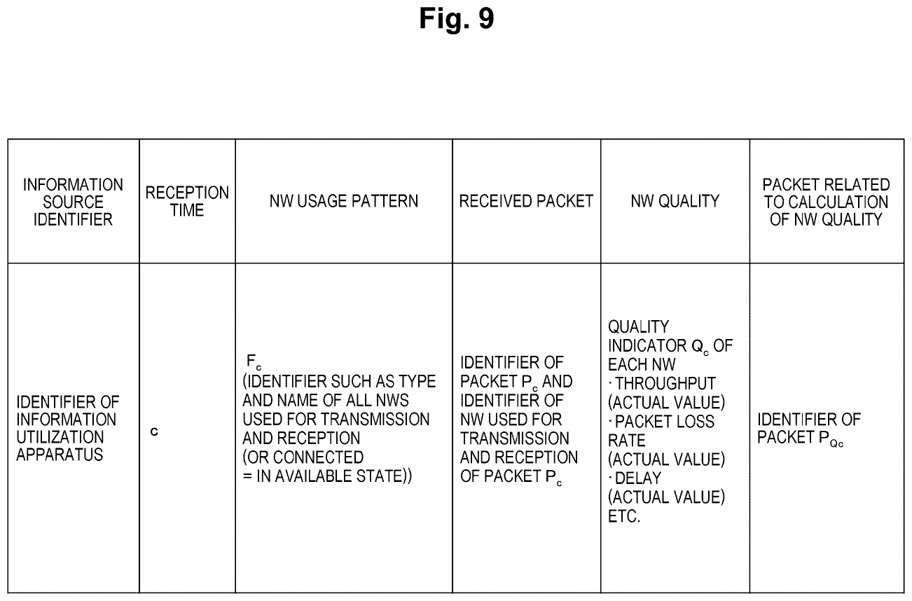

The NW quality calculation unit 15 calculates a network quality (hereinafter referred to as a “NW quality”) Q_{c} at the reception time c on the basis of the received packet P_{c}, each packet (hereinafter referred to as “packet P_{Qc}”) received until the reception time c, the transmission information output from the transmission information recording unit 12, and the like, and records information (hereinafter referred to as “reception quality information”) including the reception information, the network quality Q_{c}, and the identifier of each packet P_{Qc} in the information storage unit 18 (S113). FIG. 9 illustrates an example of a configuration of reception quality information recorded in the information storage unit 18. The NW quality is, for example, any one or more of throughput (actual value), a packet loss rate (actual value), a delay (actual value), jitter (actual value), or the like, and is an example of data observed on the information receiving side. In a case where the NW usage pattern F_{c} includes a plurality of networks, the NW quality is calculated for each network. That is, the NW quality calculation unit 15 calculates the NW quality Q_{c} for each network on the basis of the packet received via the network.

Note that, in the present embodiment, an example is illustrated in which the NW usage pattern is acquired from both the information transmission unit 22 and the information reception unit 31, but the NW usage pattern may be acquired from only one of them.

When any one of the packets transmitted from the information reception unit 31 is received and the utilization processing (video decoding or the like) of the packet is ended at an absolute time (hereinafter referred to as a “utilization time d”), the information utilization unit 32 calculates a reception result R_{d} at the video level on the basis of the packet and each packet (hereinafter referred to as a “packet P_{Rd}”) which has been utilized so far. The reception result at the video level is, for example, MDI DF/MLR, a frame rate, a bit rate, a delay, or the like (other video quality indicators such as VMAF), and is an example of data observed on the information receiving side. Alternatively, the reception result may be subjective quality (presence or absence of occurrence of human-detectable video interruption, MOS value, and the like) of the viewer of the video.

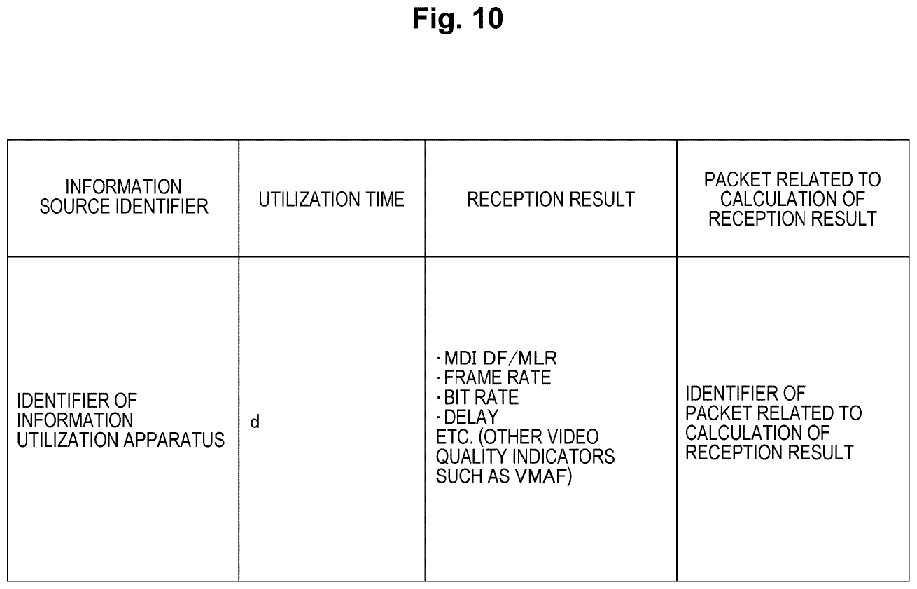

The information utilization unit 32 transmits information (hereinafter referred to as “reception result information”) including the identifier of the information utilization apparatus 30, the utilization time d, the reception result R_{d}, and the identifier of each packet P_{Rd} to the reception result recording unit 16 (S114). The reception result recording unit 16 records the reception result information in the information storage unit 18 (S115). FIG. 10 illustrates an example of a configuration of reception result information recorded in the information storage unit 18. Note that the reception time d does not necessarily need to be synchronized with another apparatus via the NTP server.

Thereafter, at an arbitrary timing (for example, a timing according to designation by the user or a predetermined timing), the transmission-reception-correspondence determination unit 17 references the information storage unit 18 (S121) and executes transmission-reception-correspondence determination processing (S122). In the transmission-reception-correspondence determination processing, the transmission-reception-correspondence determination unit 17 inversely subtracts the transmission method and the transmission time of each packet (information) on the basis of the identifier of the packet related to the calculation of the reception result of the NW quality of the video level, and specifies the location of the device 20 from the transmission time, thereby associating the NW quality or the reception result with the information transmission event (transmission time and location). Subsequently, the transmission-reception-correspondence determination unit 17 records the result of the transmission-reception-correspondence determination processing (t/Lₜ/Q_{Lt} or t/Lₜ/C_{Lt}/F_{Lt}/R_{L}) in the information storage unit 18 (S123).

Note that the recording of various types of information in the information storage unit 18 performed in FIG. 5 may be executed in real time according to an event that is a source of the information, or may be executed asynchronously with the event on the basis of a log or the like.

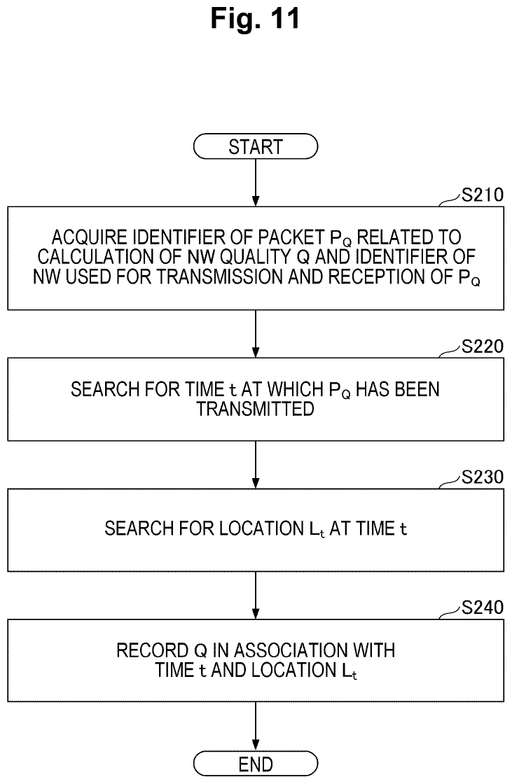

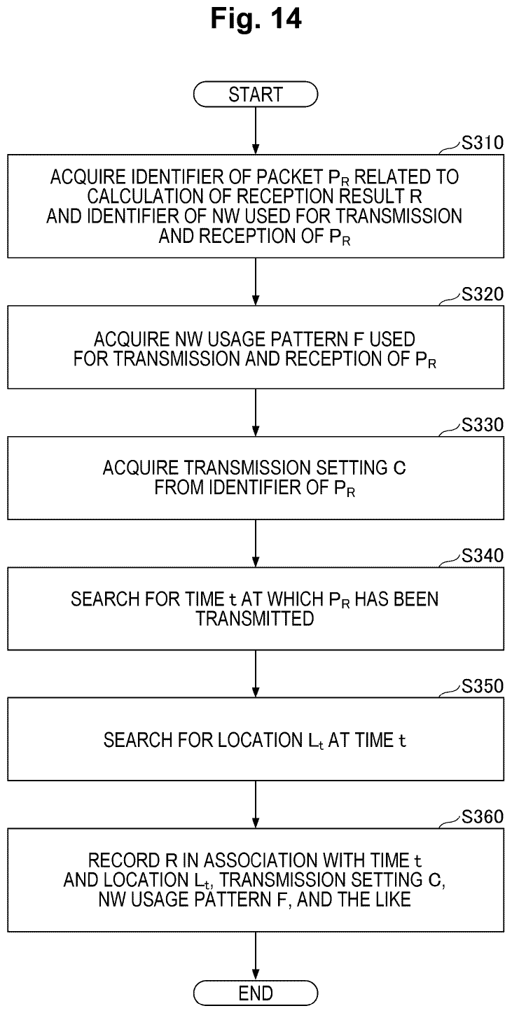

Subsequently, details of step S122 will be described. In step S122, the transmission-reception-correspondence determination unit 17 executes the following processing procedure illustrated in FIG. 11 and processing procedure illustrated in FIG. 14, or any one of the processing procedures.

FIG. 11 is a flowchart for describing an example of a processing procedure of determination processing of a correspondence relationship between an information transmission event and NW quality in the first embodiment.

In step S210, the transmission-reception-correspondence determination unit 17 acquires an identifier of a packet P_{Q} related to the calculation of NW quality Q included in certain reception quality information (FIG. 9) (hereinafter referred to as “target reception quality information”) and an identifier of the NW used for the transmission and reception of the P_{Q} from the column of the “received packet” of the certain reception quality information.

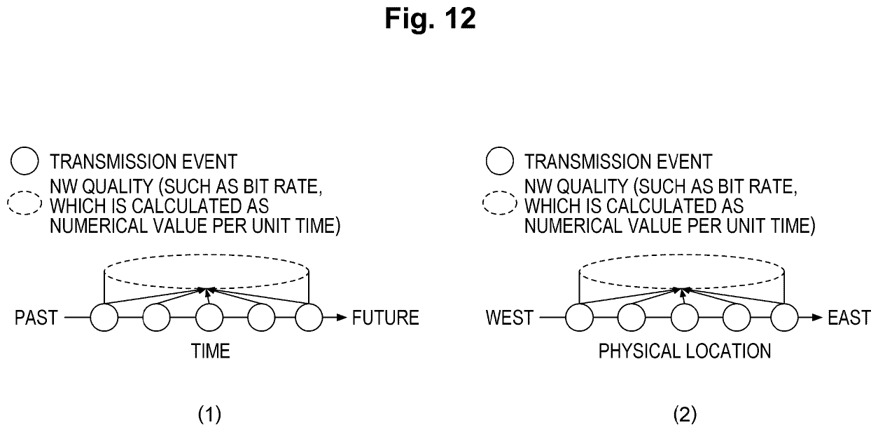

Subsequently, the transmission-reception-correspondence determination unit 17 searches the information storage unit 18 for time t at which the packet P_{Q} has been transmitted (S220). Specifically, the transmission-reception-correspondence determination unit 17 acquires, as a transmission time t of the P_{Q}, a transmission time of transmission information (hereinafter referred to as “target transmission information”) in which the value in the column of “transmission packet” is the identifier of the P_{Q} and the column of” NW usage pattern” includes the identifier of the NW used for reception of the P_{Q} in the transmission information (FIG. 7) stored in the information storage unit 18. Note that, in a case where there are a plurality of P_{Q}'s, the transmission-reception-correspondence determination unit 17 acquires the transmission time t for each P_{Q} and specifies a minimum time width (hereinafter referred to as a “transmission time section”) including all the transmission times t. That is, as illustrated in (1) of FIG. 12, a plurality of transmission times are associated with one NW quality.

Subsequently, the transmission-reception-correspondence determination unit 17 searches the information storage unit 18 for the location Lₜ of the device 20 at time t (S230). Specifically, the transmission-reception-correspondence determination unit 17 searches for time/location information including the transmission time t from the time/location information (FIG. 8) stored in the information storage unit 18, and acquires a location of the found time/location information as the transmission location Lₜ. In the present embodiment, the transmission-reception-correspondence determination unit 17 also acquires the value of the speed/attitude from the time/location information. Note that, in a case where there are a plurality of P_{Q}'s, the transmission-reception-correspondence determination unit 17 acquires the location of the device 20 at the transmission time t as the transmission location Lₜ for each P_{Q}, and specifies a minimum geographical range (hereinafter referred to as a “transmission range”) including all the transmission locations Lₜ. That is, as illustrated in (2) of FIG. 12, a plurality of transmission locations are associated with one NW quality.

Subsequently, the transmission-reception-correspondence determination unit 17 records the NW quality Q in the information storage unit 18 in association with the transmission time t (or the transmission time section), the location Lₜ (or the transmission range), and the acquired speed/attitude (S240). That is, the transmission-reception-correspondence determination unit 17 determines that the transmission time t (or the transmission time section) and the location Lₜ (or the transmission range) correspond to the NW quality Q.

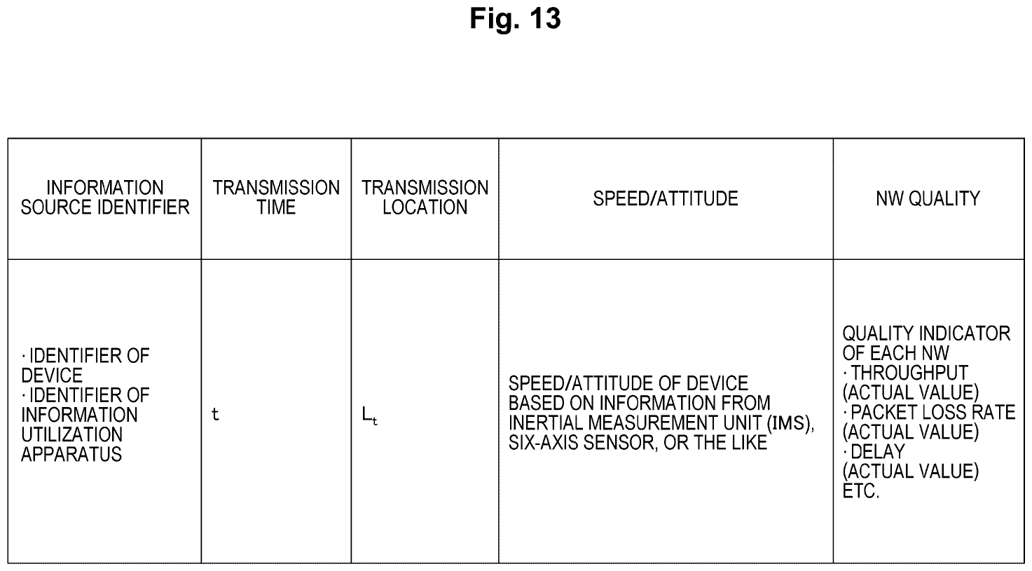

FIG. 13 illustrates an example in which the NW quality is recorded in association with the transmission time, the transmission location, and the like. FIG. 13 illustrates an example in which the NW quality is directly associated with the transmission time t and the transmission location Lₜ. However, the NW quality may be associated with a time period section to which the transmission time t (or the transmission time section) belongs among predetermined time period sections and an area section to which the transmission location Lₜ (or the transmission range) belongs among predetermined area sections. Note that the information source identifier of the target transmission information (FIG. 7) and the information source identifier of the target reception quality information (FIG. 9) are recorded in the information source identifier in FIG. 13.

The processing procedure of FIG. 11 is executed for each piece of reception quality information (FIG. 9), so that the NW quality of each piece of reception quality information (FIG. 9) is associated with the transmission time, the transmission location, and the like.

Note that, in a case where the transmission-reception-correspondence determination unit 17 executes only the processing procedure of FIG. 11 and does not execute the processing procedure of FIG. 14 to be described later, the time synchronization with the absolute time used by the time/location information recording unit 13 is unnecessary for the information generation unit 21. In addition, in a case where the transmission-reception-correspondence determination unit 17 executes only the processing procedure of FIG. 11 and does not execute the processing procedure of FIG. 14 to be described later, the transmission-reception-correspondence determination apparatus 10 may not include the generation information recording unit 11 and the reception result recording unit 16.

FIG. 14 is a flowchart for describing an example of a processing procedure of determination processing of a correspondence relationship between an information transmission event and a reception result at a video level in the first embodiment.

In step S310, the transmission-reception-correspondence determination unit 17 acquires an identifier of a packet P_{R} related to the calculation of a reception result R of certain reception result information (FIG. 10) (hereinafter referred to as “target reception result information”), and acquires an identifier of the NW used for the transmission and reception of the packet P_{R} from the column of “received packet” of the reception quality information (FIG. 9) (hereinafter referred to as “target reception quality information”) in which the identifier of the packet P_{R} is included in the column of “received packet”.

Subsequently, the transmission-reception-correspondence determination unit 17 acquires a NW usage pattern F of the target reception quality information (FIG. 9) (S320).

Subsequently, the transmission-reception-correspondence determination unit 17 acquires a transmission setting C from the generation information (FIG. 6) (hereinafter referred to as “target generation information”) in which the identifier of the packet P_{R} is included in the column of “generated packet” (S330). In a case where there are a plurality of P_{R}'s, a plurality of C's may be acquired.

Subsequently, the transmission-reception-correspondence determination unit 17 searches the information storage unit 18 for time t at which P_{R} has been transmitted (S340). Specifically, the transmission-reception-correspondence determination unit 17 acquires, as a transmission time t of the P_{R}, a transmission time of transmission information (hereinafter referred to as “target transmission information”) in which the value in the column of “transmission packet” is the identifier of the P_{R} and the value in the column of “NW usage pattern” matches the NW usage pattern F in the transmission information (FIG. 7) stored in the information storage unit 18. Note that, in a case where there are a plurality of P_{R}'S, the transmission-reception-correspondence determination unit 17 acquires the transmission time t for each P_{R} and specifies a minimum time width (hereinafter referred to as a “transmission time section”) including all the transmission times t.

Subsequently, the transmission-reception-correspondence determination unit 17 searches the information storage unit 18 for the location Lₜ of the device 20 at time t (S350). Specifically, the transmission-reception-correspondence determination unit 17 searches for time/location information including the transmission time t from the time/location information (FIG. 8) stored in the information storage unit 18, and acquires a location of the found time/location information as the transmission location Lₜ. In the present embodiment, the transmission-reception-correspondence determination unit 17 also acquires the value of the speed/attitude from the time/location information. Note that, in a case where there are a plurality of P_{Q}'s, the transmission-reception-correspondence determination unit 17 acquires the location of the device 20 at the transmission time t as the transmission location Lₜ for each P_{Q}, and specifies a minimum geographical range (hereinafter referred to as a “transmission range”) including all the transmission locations Lₜ.

Subsequently, the transmission-reception-correspondence determination unit 17 records the reception result R in the information storage unit 18 in association with the transmission time t (or the transmission time section), the location Lₜ (or the transmission range), and the acquired speed/attitude, transmission setting C, and NW usage pattern F (S360). That is, the transmission-reception-correspondence determination unit 17 determines that the transmission time t (or the transmission time section) and the location Lₜ (or the transmission range) correspond to the reception result R.

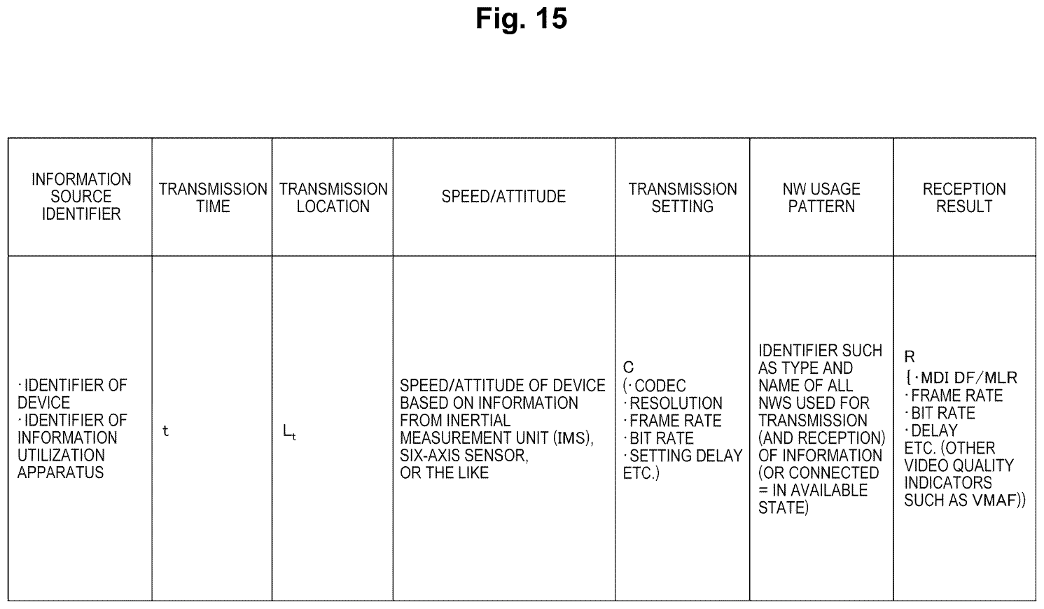

FIG. 15 illustrates an example in which a reception result at a video level is recorded in association with a transmission time, a transmission location, and the like. The information recorded indicates the reception result R in a case where the transmission setting C and the NW usage pattern F are applied at the time t and the location Lₜ. FIG. 15 illustrates an example in which the reception result is directly associated with the transmission time t and the transmission location Lₜ. However, F the reception result may be associated with a time period section to which the transmission time t (or the transmission time section) belongs among predetermined time period sections and an area section to which the transmission location Lₜ (or the transmission range) belongs among predetermined area sections. Note that the information source identifier of the target generation information (FIG. 6), the information source identifier of the target transmission information (FIG. 7), the information source identifier of the target reception quality information (FIG. 9), and the information source identifier of the target reception result information (FIG. 10) are recorded in the information source identifier in FIG. 15.

The processing procedure of FIG. 14 is executed for each piece of reception result information (FIG. 10), so that the reception result of each piece of reception result information (FIG. 10) is associated with the transmission time, the transmission location, and the like.

Note that, in a case where the transmission-reception-correspondence determination unit 17 executes only the processing procedure of FIG. 14 and does not execute the processing procedure of FIG. 11, the time synchronization with the absolute time used by the time/location information recording unit 13 is unnecessary for the information transmission unit 22.

By executing the processing procedure of FIG. 11, it becomes possible to specify whether the NW quality (particularly, in the case of an indicator represented by a quantity per unit time such as throughput or a packet loss rate) obtained on the basis of the information reception result corresponds to “when/where information is transmitted”. As a result, it is possible to create a dynamic map of the NW quality based on the information transmission event of the moving device 20 (the bandwidth is not based on the maximum value but on the actual throughput value).

Similarly, by executing the processing procedure of FIG. 14, it is possible to specify “which transmission setting” and “when/where” a result obtained by receiving a video is transmitted. As a result, a set of “time, location, video transmission setting, NW usage pattern, and reception result” can be used as the past history that serves as the selection basis for proactive control and the like to select an appropriate video streaming method.

Synchronization of the information generation unit 21 and the information transmission unit 22 with respect to an absolute time (assuming UTC) is necessary, but time synchronization among all apparatuses, which is essential in an approach based on an existing technology, can also be made unnecessary.

The creation of the heat map=dynamic map in consideration of the spatio-temporal variation according to the present embodiment can be performed on the basis of a result of information transmission and reception (for example, transmission and reception of videos in remote monitoring of automated vehicles) in actual operation. Therefore, it is not necessary to separately prepare a test vehicle for measuring the NW quality and the reception result of the video for the purpose of considering the spatio-temporal variation and to always travel on the public road. As a result, it is possible to eventually reduce the enormous measurement cost associated with the traveling of the test vehicle that increases with the expansion of the measurement range.

Note that the generation information (FIG. 6), the transmission information (FIG. 7), the reception quality information (FIG. 9), and the reception result information (FIG. 10) may not be recorded. In this case, it is sufficient if the transmission-reception-correspondence determination processing is executed for some packets in which this information is recorded. By limiting the packets in which this information is recorded to some packets, it is possible to reduce the load of the recording processing on the information storage unit 18.

As described above, according to the first embodiment, it is possible to ascertain the correspondence relationship between the data observed on the receiving side of the information and the transmission event.

Next, a second embodiment will be described. In the second embodiment, differences from the first embodiment will be described. Points not specifically mentioned in the second embodiment may be the same as those in the first embodiment.

In the first embodiment, the method for determining the correspondence relationship between the NW quality or the reception result and the information transmission event on the basis of the identifier of the packet related to the calculation of the NW quality or the reception result has been described. In the second embodiment, a method of determining the correspondence relationship between the NW quality or the reception result and the information transmission event on the basis of the delay (hereinafter referred to as “transmission delay”) related to the packet transmission between the information transmission unit 22 and the information reception unit 31 or the delay (hereinafter referred to as “processing delay”) related to the processing from the start of the packet generation by the information generation unit 21 to the end of the utilization of the video by the information utilization unit 32 will be described.

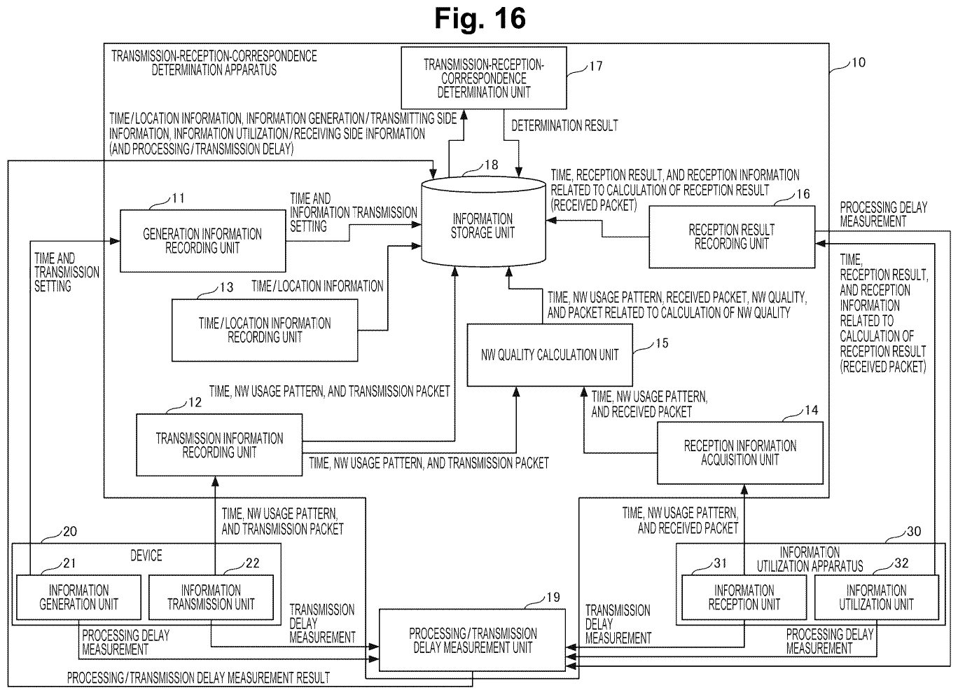

FIG. 16 is a diagram illustrating an example of a functional configuration of an information processing system according to the second embodiment. In FIG. 16, the same or corresponding parts as those in FIG. 4 are denoted by the same reference signs. In FIG. 16, the transmission-reception-correspondence determination apparatus 10 further includes a delay measurement unit 19.

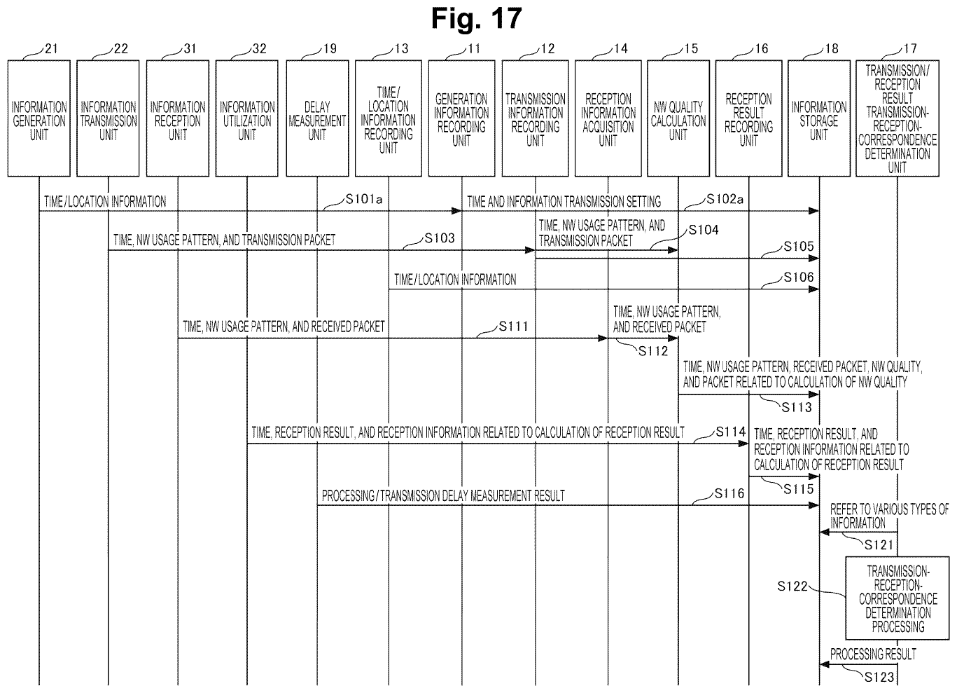

FIG. 17 is a sequence diagram for describing an example of a processing procedure executed in the information processing system according to the second embodiment. In FIG. 17, steps that are the same as or correspond to those in FIG. 5 are denoted by the same step numbers, and the description thereof will be omitted as appropriate.

In FIG. 17, steps S101 and S102 are replaced with steps S101a and S102a. Additionally, step S116 is added. These steps will be described below.

In step S101a, the information generation unit 21 generates a packet Pₐ storing the acquired video, and transmits generation information including the acquisition time a at which the video is acquired, the transmission setting Cₐ of the video at the acquisition time a, and the information source identifier to the generation information recording unit 11.

Upon receiving the generation information (information source identifier, a, and Cₐ) from the information generation unit 21, the generation information recording unit 11 records the generation information in the information storage unit 18 (S102a). That is, in the second embodiment, the generation information need not include the identifier of the packet Pₐ.

Furthermore, the delay measurement unit 19 periodically measures the transmission delay and the processing delay, and records the respective measurement results of the transmission delay and the processing delay in the information storage unit 18 in association with the respective measurement times (S116).

Note that it is sufficient if the transmission delay and the processing delay are measured using known techniques.

For example, communication delay measurement using a round trip time (RTT) may be used. This is a mechanism for correcting a communication delay used in a general network time protocol (NTP). A round-trip delay is calculated on the basis of time information described in an NTP packet exchanged between the NTP server and the NTP client via the NW, and half of the round-trip delay is estimated to be a one-way delay. When the node on the transmitting side and the node on the receiving side are time-synchronized, the transmission time can be estimated by subtracting the one-way delay estimated in advance from the reception time of the node on the receiving side.

Furthermore, communication delay measurement using a synchronized time stamp (STS) may be used. This is a method of calculating a one-way delay by transmitting and receiving a measurement packet between nodes time-synchronized in UTC (Coordinated Universal Time) using a global navigation satellite system (GNSS).

Details of step S122 in the second embodiment will be described.

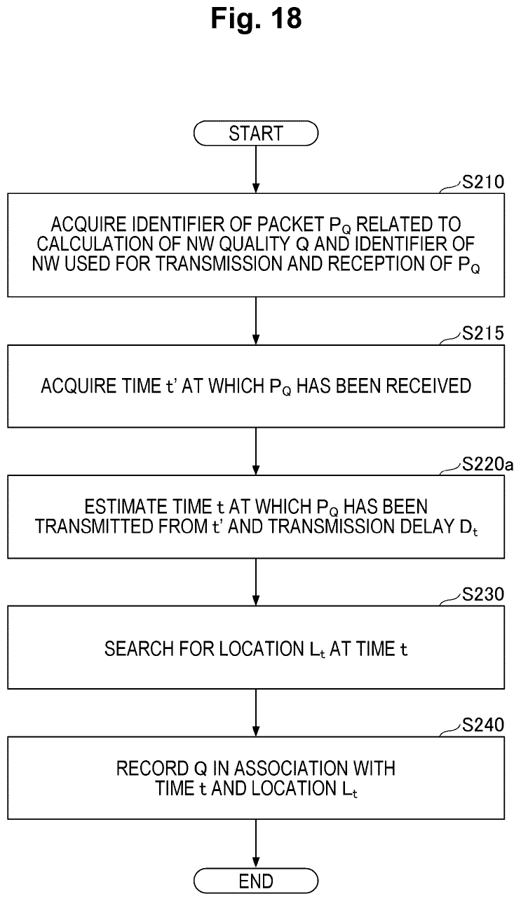

FIG. 18 is a flowchart for describing an example of a processing procedure of determination processing of a correspondence relationship between an information transmission event and NW quality in the second embodiment. In FIG. 18, steps that are the same as those in FIG. 11 are denoted by the same step numbers, and the description thereof will be omitted as appropriate. In a case where the transmission-reception-correspondence determination unit 17 executes the processing procedure of FIG. 18, it is sufficient if the information reception unit 31 is time-synchronized with the absolute time (absolute time used by the time/location information recording unit 13).

Step S210 is the same as that in FIG. 11. That is, in step S210, the transmission-reception-correspondence determination unit 17 acquires the identifier of the packet P_{Q} related to the calculation of the NW quality Q included in certain reception quality information (FIG. 9) (hereinafter referred to as “target reception quality information”) and the identifier of the NW used for the transmission and reception of the P_{Q} from the column of the “received packet” of the certain reception quality information.

Subsequently, the transmission-reception-correspondence determination unit 17 acquires the time t′ at which the P_{Q} has been received from the column of “reception time” of the target reception quality information (FIG. 9) (S215). In a case where there are a plurality of P_{Q}'s, the transmission-reception-correspondence determination unit 17 specifies a minimum time width including the time t′ of each P_{Q}.

Subsequently, the transmission-reception-correspondence determination unit 17 estimates the time t at which the P_{Q} has been transmitted on the basis of a transmission delay Dₜ measured by the delay measurement unit 19 with respect to the time t′ (S220a). Specifically, the transmission-reception-correspondence determination unit 17 estimates t′−Dₜ as t. In a case where there are a plurality of P_{Q}'s, the transmission-reception-correspondence determination unit 17 specifies a minimum time width (reception time section) including the time t estimated for each P_{Q}. Note that a value measured in advance or a fixed estimated value may be used as Dₜ.

From step S230 onward, the same processing as in FIG. 11 is executed using the estimated time t.

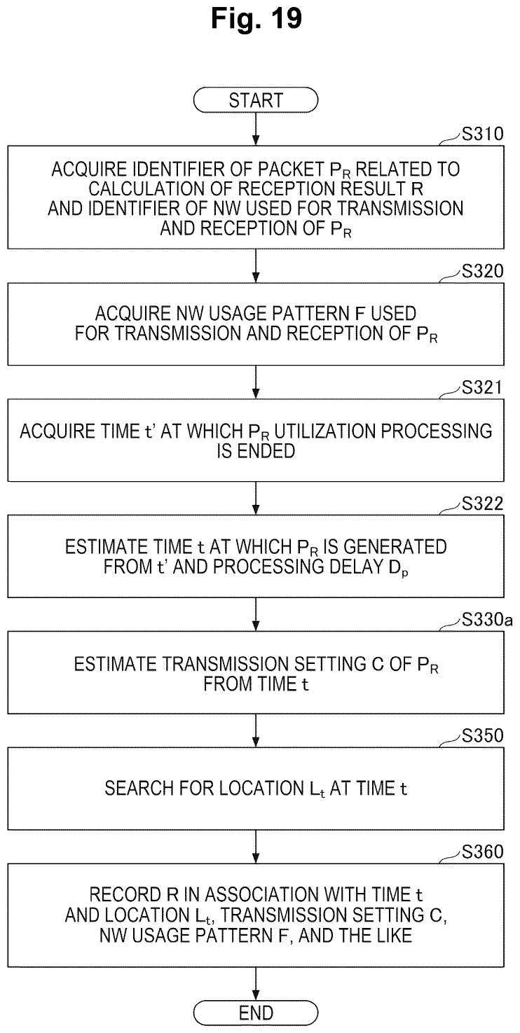

Note that, in a case where the transmission-reception-correspondence determination unit 17 executes only the processing procedure of FIG. 18 and does not execute the processing procedure of FIG. 19 to be described later, the transmission-reception-correspondence determination apparatus 10 may not include the generation information recording unit 11 and the reception result recording unit 16.

FIG. 19 is a flowchart for describing an example of a processing procedure of determination processing of a correspondence relationship between an information transmission event and a reception result at a video level in the second embodiment. In FIG. 19, steps that are the same as those in FIG. 14 are denoted by the same step numbers, and the description thereof will be omitted as appropriate. In a case where the transmission-reception-correspondence determination unit 17 executes the processing procedure of FIG. 19, it is sufficient if the information generation unit 21 and the information utilization unit 32 is time-synchronized with the absolute time (absolute time used by the time/location information recording unit 13).

Step S310 is the same as that in FIG. 14. That is, in step S310, the transmission-reception-correspondence determination unit 17 acquires an identifier of a packet P_{R} related to the calculation of a reception result R of certain reception result information (FIG. 10) (hereinafter referred to as “target reception result information”), and acquires an identifier of the NW used for the transmission and reception of the packet P_{R} from the column of “received packet” of the reception quality information (FIG. 9) (hereinafter referred to as “target reception quality information”) in which the identifier of the packet P_{R} is included in the column of “received packet”.

Step S320 is the same as that in FIG. 14.

Subsequent to step S320, the transmission-reception-correspondence determination unit 17 acquires the time t′ at which the P_{R} utilization processing is ended from the column of “utilization time” of the target reception result information (FIG. 10) (S321).

Subsequently, the transmission-reception-correspondence determination unit 17 estimates the time t at which the P_{R} is generated by the information generation unit 21 on the basis of a processing delay Dₚ measured by the delay measurement unit 19 with respect to the time t′ (S322). Specifically, the transmission-reception-correspondence determination unit 17 estimates t′−Dₚ as t. In a case where there are a plurality of P_{R}'s, the transmission-reception-correspondence determination unit 17 specifies a minimum time width (hereinafter referred to as a “generation time section”) including the time t estimated for each P_{R}. Note that a value measured in advance or a fixed estimated value may be used as Dₚ.

Subsequently, the transmission-reception-correspondence determination unit 17 estimates the transmission setting C of the P_{R} on the basis of the time t (S330a). Specifically, the transmission-reception-correspondence determination unit 17 estimates, as C, the transmission setting of the generation information whose acquisition time t is the time t among the generation information (FIG. 6) recorded in the information storage unit 18. In a case where there are a plurality of P_{R}'S, a plurality of C's may be estimated.

In step S350, the above-mentioned time t and transmission setting C are used to execute the same processing as in FIG. 14.

By executing the processing procedure of FIG. 18, an effect similar to that in the case of executing the processing procedure of FIG. 11 can be obtained (here, this differs from FIG. 11 in that the information reception unit 31 needs time synchronization).

In addition, by executing the processing procedure of FIG. 19, an effect similar to that in the case of executing the processing procedure of FIG. 14 can be obtained (here, this differs from FIG. 14 in that the information generation unit 21 and the information utilization unit 32 need time synchronization).

Note that, in the transmission-reception-correspondence determination processing in the second embodiment, as compared with the transmission-reception-correspondence determination processing in the first embodiment, the accuracy of association with the transmission event is considered to be inferior because the packet is not completely specified, but it is considered that sufficient accuracy can be obtained as the determination function of the transmission/reception result depending on the synchronization accuracy with the absolute time, the measurement accuracy of the processing/transmission delay, and the usage of the transmission/reception result database.

In addition, since the processing procedure of FIG. 18 (processing of associating the NW quality with the transmission event) can be completed only on the information reception unit 31 side (the upper side of the NW), there is an advantage in ease of mounting configuration.

In the processing procedure of FIG. 19 (processing of associating a reception result at the video level with a transmission event), it is necessary to acquire the time synchronization and the transmission setting of the information generation unit 21, but it is not necessary to acquire the information up to the packet level. Therefore, the processing can be performed by general log acquisition.

In each of the above embodiments, the transmission-reception-correspondence determination apparatus 10 is an example of a transmission-reception-correspondence determination system. The NW quality calculation unit 15 or the reception result recording unit 16 is an example of an observation data recording unit.

Although the embodiments of the present invention have been described in detail above, the present invention is not limited to these specific embodiments, and various modifications and changes can be made within the scope of the gist of the present invention described in the claims.

### REFERENCE SIGNS LIST

10 Transmission-reception-correspondence determination apparatus
11 Generation information recording unit
12 Transmission information recording unit
13 Time/location information recording unit
14 Reception information acquisition unit
15 NW quality calculation unit
16 Reception result recording unit
17 Transmission-reception-correspondence determination unit
18 Information storage unit
19 Delay measurement unit
20 Device
21 Information generation unit
22 Information transmission unit
30 Information utilization apparatus
31 Information reception unit
32 Information utilization unit
100 Drive device
101 Recording medium
102 Auxiliary storage device
103 Memory device
104 Processor
105 Interface device
B Bus

1. A transmission-reception-correspondence determination system comprising:
a processor; and
a memory storing program instructions that cause the processor to:
record information indicating a relationship between a location of a moving device and time;
record identifiers of pieces of information transmitted from the device in association with transmission times of the pieces of information;
record an identifier of information transmitted from the device and data observed regarding the information in an apparatus that has received the information via a network in association with each other; and
determine that a transmission time associated with an identifier that is same as the recorded identifier among the identifiers of the pieces of information and a location of the device at the transmission time correspond to the data associated with the recorded identifier.

2. A transmission-reception-correspondence determination system comprising:
a processor; and
a memory storing program instructions that cause the processor to:
record information indicating a relationship between a location of a moving device and time;
record data observed regarding information transmitted from the device in an apparatus that has received the information via a network and a reception time of the information in association with each other; and
estimate a time at which the device has transmitted the information related to the reception time based on the recorded reception time and a delay related to transmission of the information from the device to the apparatus, and determine that the time and a location of the device at the time correspond to the data observed regarding the information related to the reception time.

3. The transmission-reception-correspondence determination system according to claim 1, wherein the identifier of the information is an identifier of a packet storing the information.

4. The transmission-reception-correspondence determination system according to claim 1, wherein the observed data is any one or more of throughput, a packet loss rate, delay, or jitter.

5. A transmission-reception-correspondence determination method executed by a computer, the method comprising:
recording information indicating a relationship between a location of a moving device and time;
recording identifiers of pieces of information transmitted from the device in association with transmission times of the pieces of information;
recording an identifier of information transmitted from the device and data observed regarding the information in an apparatus that has received the information via a network in association with each other; and
determining that a transmission time associated with an identifier that is same as the recorded identifier among the identifiers of the pieces of information and a location of the device at the transmission time correspond to the data associated with the recorded identifier.

6. (canceled)

7. (canceled)

8. (canceled)

9. A non-transitory computer-readable recording medium storing a program for causing a computer to execute the transmission-reception-correspondence determination method of claim 5.
